(19) United States
(12) Patent Application Publication
(10) Pub. No.: US 2022/0307102 A1
(43) Pub. Date: Sep. 29, 2022

(54) HIGH PRODUCTIVITY PLANT FOR THE QUENCHING OF STEEL BARS, QUENCHING MACHINE AND CORRESPONDING METHOD FOR QUENCHING STEEL BARS

(71) Applicants: DANIELI & C. OFFICINE MECCANICHE S.P.A., Buttrio (IT); DANIELI CENTRO COMBUSTION S.P.A., Cinisello Balsamo (IT)

(72) Inventors: Enrico MOZZI, Genova (IT); Fabrizio PERE, Genova (IT)

(21) Appl. No.: 17/597,184

(22) PCT Filed: Jul. 7, 2020
(86) PCT No.: PCT/IT2020/050170

§ 371 Date: Dec. 28, 2021

(30) Foreign Application Priority Data
Jul. 12, 2019 (IT) 102019000011559

(51) Int. Cl. C21D 9/00; C21D 1/58; C21D 1/667; C21D 11/00

(52) U.S. Cl. CPC C21D 9/0056; C21D 1/58; C21D 1/667; C21D 11/005; C21D 9/0012; C21D 9/0018; C21D 9/0062; C21D 9/0075

(57) ABSTRACT

High productivity plant for the continuous quenching of steel bars which comprises a loading station suitable to dispose a plurality of bars separated and distanced from each other. Such plant also comprises a first treatment line, a quenching machine, a transfer station disposed downstream of the quenching machine, and a second treatment line.

### FIELD OF THE INVENTION

The present invention concerns a high productivity plant for the quenching of steel bars. In particular, a quenching plant according to the present invention is suitable to perform a quenching treatment on several bars simultaneously.

The invention also concerns a furnace and a quenching machine used in said plant.

Furthermore, the invention also concerns a quenching method which uses the plant and machine as above.

### BACKGROUND OF THE INVENTION

It is known that in order to improve the mechanical properties of metal products such as, for example, steel bars, the latter are subjected to a hardening and tempering heat treatment. This treatment, defined as quenching, consists in subjecting the steel bars to be treated to one or more heating cycles followed by rapid cooling.

The quenching treatment provides that the steel undergoes a process divided into at least three main steps, performed in the following order: a step of high heating, a step of rapid cooling and finally a further step of heating/cooling, respectively performed by suitable apparatuses such as for example an austenitization furnace, a quenching machine and a tempering furnace.

For the quenching treatment, plants are known which allow to treat a single steel bar at a time or groups of bars.

Quenching plants can also treat the bars by adopting a “continuous” process or a “discontinuous or batch” process, as defined below.

The “discontinuous or batch” process provides that the bar/bars receives/receive all the treatments while remaining almost static in the same position during substantially the whole treatment, therefore during the heating and cooling operations.

One disadvantage of plants that use this “discontinuous” process is that the treatment is uneven.

In fact, in these plants it is necessary to support the steel bar (or the bars) statically during the treatment, which causes limitations to the penetration of the heat (in the heating step) or cold (in the cooling step) where the bar (or the bars) rests/rest on the corresponding support.

This disadvantage arises both in the treatment of the single bar and also, even worse, in cases where, in order to increase productivity, several steel bars are treated simultaneously.

In fact, the use of this solution makes it necessary to dispose the superimposed and/or adjacent bars, distanced or possibly in contact with each other, not homogeneously distanced with respect to the components of the plant, which worsens the unevenness in the treatment both in the bar (in particular where it rests and/or is in contact with parts of the plant) and also between bar and bar.

Quenching plants are also known which provide to use the process defined as “continuous”, which provides that the bar advances during the treatment, thus proceeding in “movement” from one step to the next.

Known quenching plants which adopt a “continuous” process generally provide to treat only one bar at a time.

Therefore, a new bar to be treated can enter the quenching plant only after the previous bar has traveled a certain distance to allow it to be inserted, without risking unwanted contacts between the bars.

An obvious disadvantage of a “continuous” quenching plant is therefore the considerable limitation in productivity due to the treatment of single bars.

Inevitably, to increase productivity it is possible to modify a single parameter, that is, the speed of advance of the bar inside the treatment machines.

Given that the distance traveled is constrained by the time required to complete each step (both the heating and the cooling step) due to the conductivity of the steel, and given that bars with larger diameters require more time to complete each individual step, it is obvious that as the diameter of the bars to be treated gradually increases, the time between the insertion of one bar and the following bar also increases.

This disadvantage worsens all the more as the diameter of the treated bars increases.

In fact, due to physical and thermodynamic requirements attributable to the “conductivity” of the metal of which the bar is made (and its diameter) it is not allowed to excessively increase the speed of advance of the steel bar. In fact, it is necessary to guarantee that the bar stays for the correct time in each step, in order to allow both the heat to reach the bar in depth and also for the opposite effect during cooling, essentially imposing limits on the speeds given the same sizes of the quenching plant.

Therefore, increasing the speed of advance to improve productivity would entail an oversizing of the plant, causing loss of effectiveness in the treatment and inevitable increase in costs.

Known quenching plants therefore do not allow to increase productivity without sacrificing the quality of the treatment, or such plants must necessarily be complex, expensive and oversized.

JP 2011184712 describes a heating furnace for bars and a cooling device located downstream of the heating furnace. A roller-type transporter transports the bars inside the heating furnace and through the cooling device. The cooling device can assume an operating position and a retracted position.

CN 109295286 describes a quenching device and in particular a quenching device comprising a primary quenching device and a secondary quenching device.

It is also known that quenching plants provide that the quenching machine generally performs the rapid cooling of the bars by means of flows of cooling fluid.

It is also known that quenching machines of the type with flows of cooling fluid use a “cascade” flow provided only in one direction, for example radial or with a flow from above or from below.

It is also known that such quenching machines use flows whose delivery position/distance with respect to the steel bar is generally not modifiable.

It is also known that quenching machines use orientable or non-orientable and non-focused flows of cooling fluid on specific portions of the bar to be cooled.

It is also known that quenching plants can provide quenching machines which perform rapid cooling by immersion in the cooling fluid contained in a tank.

One disadvantage of immersion cooling is that the movement of the bars inside a tank entails an inevitable contact between the bars and the support that moves them, thus hindering the dispersion of heat from those areas.

Another disadvantage is that, during the immersion step, areas of the bars will come into contact with the cooling fluid at different times.

One disadvantage, therefore, of these known quenching machines is that the contact between metal and cooling fluid is particularly dis-homogeneous.

Another disadvantage is that in these quenching machines the cooling fluid comes into contact with the steel bar on different areas and at different times.

The rapid cooling step is a critical step of the quenching treatment since an application of the cooling fluid on the steel bars that is not homogeneous or not simultaneous over the whole surface of the bar can influence the uniformity of the quality of the quenching and compromise the quality of the bars themselves.

Finally, one disadvantage common to both types of known quenching machines is that the quenching treatment produces deformations and/or bends of the steel bars treated.

Based on all the disadvantages described above, there is therefore a need to perfect a quenching plant which can overcome at least one of the disadvantages of the state of the art.

In particular, one purpose of the present invention is to provide a high productivity quenching plant of the “continuous” type.

Another purpose of the present invention is to provide a quenching plant which is not excessively bulky, as well as relatively simple to manage and functional.

Another purpose of the present invention is to provide a quenching plant that uses apparatuses that are easy to maintain.

Another purpose of the present invention is to provide an efficient quenching plant, suitably sized and which allows advantageous cost management.

Another purpose of the present invention is to provide a quenching machine which provides a uniform treatment of the steel bars.

Another purpose of the present invention is to provide a quenching machine which minimizes the deformations of the treated bars.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

The present invention concerns a quenching plant in accordance with claim 1, which uses a “continuous” process, provided with particular technical solutions, geometric characteristics and corresponding apparatuses, for the high productivity quenching of a plurality of steel bars simultaneously.

According to the present invention, the quenching plant essentially comprises a first and a second treatment line, joined at one respective end by means of a transfer station.

In one solution of the present invention, the two treatment lines are substantially parallel and the direction of feed of the material to be treated between the first and second lines is inverted by 180°.

In an alternative solution, the second treatment line is substantially aligned with the first treatment line and is a continuation thereof, so that the transfer station determines only the passage from one line to the other without causing a change of direction.

It is also possible for the two treatment lines to be angled with respect to each other, this due to the size and/or logistics of the factory in which the plant is installed.

The transfer station provides to move the steel bars from the first to the second treatment line.

The steel bars to be treated are fed along the plant by feed means disposed in series along the two treatment lines. Such feed means can be, for example, rollers.

According to the invention, in order to increase productivity, the quenching plant uses rollers that allow to simultaneously feed several bars parallel and adjacent to each other.

According to the invention, at least in the first treatment line the rollers have a support surface that has V-shaped hollows suitable to receive and substantially stabilize the bars that they transport.

The bars on which the plant operates can have, for example, diameters comprised between 15 mm and 100 mm, although this value should not be considered as a limitation. The V-shaped hollows will have a size coherent with the value of the diameter of the bars that are processed in the plant.

This conformation of the rollers allows to guarantee uniformity of treatment, uniformity of metallurgical and mechanical results, prevent thermal shocks and minimize instances of deformation of the bars.

In this regard, the cavities present in the rollers are equally spaced and suitably shaped to prevent unwanted oscillations of the bars as they are fed and keep them equidistant from each other, thus guaranteeing uniform treatment.

Furthermore, the rollers are disposed angled with respect to the axis of feed, so as to induce a rotation of the bars along the longitudinal axis as they are fed. In particular, the angle of disposition of the rollers with respect to the direction of feed is different from 90°.

The spacing between the adjacent bars and the simultaneous rotation thereof allows to guarantee all the generatrices constituting the surface of the bars a substantially homogeneous and symmetrical exposure with respect to the surrounding environment.

Along the feed line there is an austenitization furnace suitable to guarantee a uniform heat radiation over the entire length of the roller, and therefore on all the bars disposed thereon, so that even the most external bars can benefit from the characteristics generated by the roller itself.

At exit from the austenitization furnace the bars are subjected to the quenching treatment by means of a quenching machine, which has the purpose of abruptly reducing the temperature of the bars by means of flows of cooling fluid emitted by cooling elements.

If the temperature reduction does not occur homogeneously throughout the entire bar, there is a risk of obtaining deformed or badly quenched bars.

The invention also concerns a quenching machine for a plant to quench steel bars comprising a base and a cover, inside which an internal space is made.

Feed means are disposed in this internal space to simultaneously feed such plurality of bars, and at the same time rotate them on their own axis. Such feed means define a support surface for the bars. In the internal space there is also present a plurality of cooling elements disposed respectively above and below the feed means and configured to spray cooling fluid on the steel bars in transit. The bars are moved simultaneously by means of the feed means in a direction of feed in which these bars lie. The plurality of cooling elements disposed above the bars is adjustable in height with respect to their feed plane.

The distance between the cooling elements located above and the means to feed the bars is therefore adjustable so as to allow to obtain a better symmetry of the flows of cooling fluid that reach the bars.

To further optimize the symmetry, according to another aspect of the present invention, the flows of fluid are emitted by nozzles whose position can be fixed, or adjustable at least in direction and angle of delivery.

These aspects of adjustability provide the additional advantage of possibly being able to simultaneously work bars of different diameters, acting appropriately on the positioning parameters of the delivery nozzles.

Downstream of the quenching machine, a transfer station transfers the bars cooled in the second treatment line. As stated, in a non-limiting solution of the present invention the second line is substantially parallel to the first and defines a direction of feed opposite to it.

In one aspect of the invention, the second treatment line has rollers of a different type with respect to those of the first line.

In the second treatment line, the rollers are disposed substantially orthogonal to the axis of feed of the bars and have a flat surface which allows, if necessary, to feed a greater number of bars with respect to the rollers of the first line, for example to transport bars treated in several cycles and accumulated, for example, in the transfer station.

In any case, it is within the scope of the present invention that also in the second treatment line the rollers for transporting the bars have the conformation with V-shaped hollows described above in relation to the first treatment line.

Based on what described above, the invention provides a quenching plant which allows to carry out a quenching process on a plurality of steel bars simultaneously, and therefore with the advantage of an increase in production substantially equal to the number of bars that can be treated simultaneously, also guaranteeing high quality and uniformity of the treatment.

### ILLUSTRATION OF THE DRAWINGS

These and other aspects, characteristics and advantages of the present invention will become apparent from the following description of some embodiments, given as a non-restrictive example with reference to the attached drawings wherein:

FIG. 1 is an example, schematic top view of a quenching plant in accordance with the present invention;

FIG. 2 is a transverse perspective view of a roller (and steel bars) provided for use in a quenching plant in accordance with the present invention;

FIGS. 3a-3b are a detail of a roller of FIG. 2;

FIG. 4 is a cross-section of a quenching machine in accordance with the present invention;

FIG. 5 is a longitudinal section of specific elements of the quenching machine of FIG. 4.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF EMBODIMENTS

We will now refer in detail to the various embodiments of the invention, of which one or more examples are shown in the attached drawings. Each example is supplied by way of illustration of the invention and is not understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

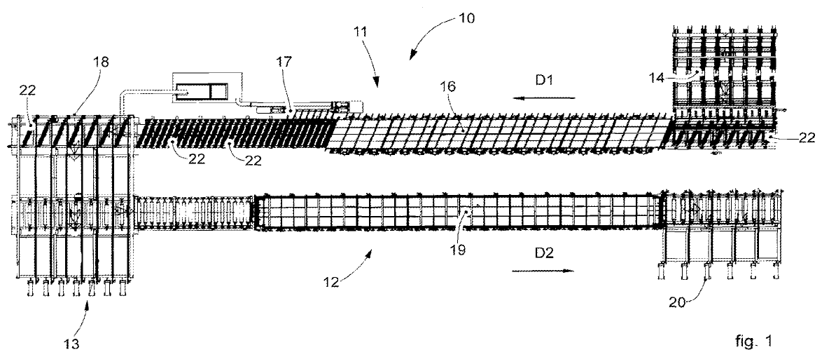

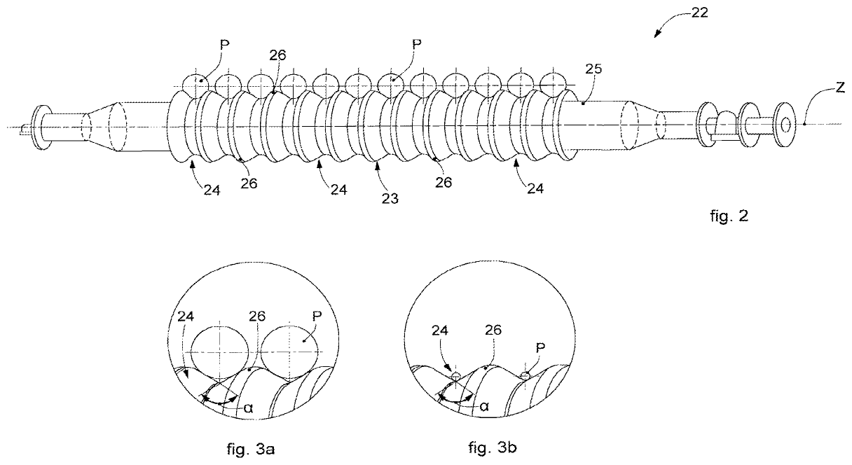

The present invention concerns a quenching plant, indicated as a whole with reference number 10, configured to operate in “continuous” mode on a plurality of steel bars P, see FIG. 1 and FIG. 2.

In order to exemplify the invention, the following description and the accompanying drawings concern a quenching plant that allows to simultaneously treat a number of steel bars, with a diameter comprised between 15 mm and 100 mm, equal to twelve (FIG. 2). It is however clear that different embodiments can be provided to treat a different number of steel bars and also with different diameters, without thereby departing from the scope of the invention.

FIG. 1 shows a top view of a quenching plant 10 comprising two treatment lines, respectively a first line 11 and a second line 12, substantially parallel to each other and with opposite directions of feed D1 and D2.

The terminal end of the first line 11, in relation to the direction of feed, is associated with the initial end of the second line 12 by means of a transfer station 13.

According to other possible embodiments, not shown here, the first line 11 and the second line 12 can be aligned on a same feed line, or also be angled with respect to each other by any angle whatsoever, according to the factory logistics and/or usage requirements. In this case, the transfer station 13 will be limited to a connection zone between the two lines.

The first line 11 comprises a first furnace 16, or austenitizing furnace, and a quenching machine 17, and it is fed, at its initial end, with steel bars P through a loading station 14.

The second line 12 comprises a tempering furnace 19 and a station 20 for unloading the steel bars P.

The first and second lines 11, 12 provide a series of rollers, disposed transversely to a direction of feed D1 and D2 respectively, conformed to simultaneously move a plurality of steel bars P along the quenching plant 10.

The rollers can be disposed substantially along the entire development of the lines 11, 12.

The rollers can also be disposed more or less close to each other, according to requirements.

In accordance with the tests carried out by the Applicant, for example purposes only and not as a limitation of the invention itself, the quenching plant described here can reach a productivity, referring, for example, to steel bars P of 50 mm in diameter, of about 3 tons/h and up to about 6 tons/h in the case of bars P with a diameter of 100 mm.

It is understood that these values are purely indicative, and can vary even considerably based on the type of plant and individual production needs, increasing or decreasing the number of bars treated simultaneously, their diameter and other design parameters of the plant.

The first line 11 of the quenching plant 10 is provided with rollers 22 in accordance with FIG. 2, which have on one surface 23 a plurality of cavities 24 substantially orthogonal with respect to the axis Z of the roller 22, which are defined essentially in the shape of a V with angle α, by ribs 26 and in which each of said cavities 24 is configured to receive a steel bar P. The rollers 22 are an example of means for simultaneously moving the bars P in the direction of feed D1, or D2.

According to some embodiments, the number of cavities 24 present in one roller 22 can be comprised between 6 and 18, preferably between 8 and 16, more preferably between 10 and 14, based on the number of bars P to be treated simultaneously and compatibly with the design sizes of the respective furnaces 16, 19 and quenching machine 17. For example, a roller 22 can have a length, measured between two extreme ribs 26, comprised between 1400 mm and 2000 mm, more preferably between 1600 mm and 1800 mm. Advantageously, it can be provided that the furnaces 16 and/or 19 and/or the quenching machine 17 are sized according to the length of the rollers 22.

The cavities 24 can be advantageously identical to each other and equidistant. The cavities 24 can also be sized so they adapt to a specific range of bars, for example, by modifying the amplitude of the angle α. Consequently, the height of the ribs 26 will also be modified, preventing involuntary and unwanted accidental contacts between steel bars P positioned on adjacent cavities 24.

Some embodiments provide that the angle α is comprised between 100° and 130°, preferably between 110° and 120°.

One exemplary and non-limiting embodiment of a roller 22, such as that shown in FIGS. 3a-3b, provides an angle α of the cavity around 115° which allows to stably house steel bars P with a diameter from 15 mm to 100 mm, maintaining the bars adequately and advantageously separated to receive a homogeneous quenching treatment and to prevent even accidental contacts between them.

As shown in FIG. 1, the treatment line 11 can provide a series of rollers 22, as shown in FIG. 2, substantially parallel to each other and having a longitudinal axis inclined with respect to the direction of feed D1 of the steel bars P.

This inclination generates a rotation of the bars P on their longitudinal axis simultaneous with the feed along the line 11.

The quenching plant 10 comprises, cooperating with the initial end of the first line 11, a loading station 14 configured to receive bundles of steel bars P to be quenched and to be correctly sent to the beginning of the treatment in the first line 11.

In particular, in the loading station 14 the bars are spread out, separated and aligned with each other so that they can be arranged one for each cavity 24.

According to some embodiments, the loading station 14 can simultaneously load onto the rollers 22 a number of steel bars P equal to the number of cavities 24.

The loading station 14 can be conformed to simultaneously introduce in the first line 11 one or more bars P, preferably a number of bars P equal to the cavities 24 of the rollers 22.

The loading can take place with the rollers 22 moving or stationary.

Preferably, steel bars P having approximately the same diameter are loaded. However, it is not excluded that the bars P treated simultaneously can also have different diameters from each other.

The steel bars P loaded on line 11 move from the loading station 14 up to the entrance to the furnace 16 where they are taken inside to be heated.

The rotation speed of the rollers 22 that enter the furnace 16 can be adjusted in relation to the treatment time requirements to be respected, for example as a function of the diameter of the steel bars P, the length of the furnace, the temperature inside the furnace 16, based on the design criteria used for the first phase of the quenching process.

At the exit of the furnace 16 there is provided a quenching machine 17, described in detail below, provided to induce a sharp drop in the temperature of the steel bars P at exit from the furnace 16 by means of delivery of flows of cooling fluid directed onto the bars.

The steel bars P exit through a mobile closing partition which can be re-shut when the bars have passed to prevent the entry of ambient air into the furnace 16 itself.

The exit speed of the steel bars P is adjustable by modifying the rotation speed of the rollers 22 at least of the last section in the furnace 16, thus reducing possible temperature imbalances between the two ends of the bar P caused by excessively long exit times, thus allowing to improve the quenching process.

The steel bars P are fed until they reach the final end of the first line 11, arriving at a transfer station 13.

The transfer station 13 moves the bars P orthogonally with respect to the direction of movement of the line 11 toward the line 12.

The line 12, unlike the line 11, can be provided with a series of rollers with a flat support surface of the bars P and designed to simultaneously move a greater number of steel bars P, for example 24. Furthermore, these rollers can be disposed not inclined with respect to the direction of feed of the bars, but rather orthogonally. Basically, the rollers of the line 12 do not have the cavities 24, but a single support surface of the different bars P.

This solution is particularly advantageous during a subsequent tempering process inside the furnace 19, since the bars P are disposed in a single layer increasing the linear weight of the charge, with a consequent increase in the productivity of the furnace.

From the end of the first line 11 the bars P move toward the tempering furnace 19, where they undergo the tempering process. The furnace 19, thanks to the feed structure with transverse rollers, can be advantageously made with compact sizes.

In other embodiments, the second treatment line 12 can provide rollers 22 configured as in the first treatment line 11.

In other embodiments, the second line 12 can be suitably configured to be provided with a tempering furnace 19 of the Walking Beam (WB) or Archimedes' screw type.

After the tempering furnace 19, the steel bars P are taken to an unloading station 20 where, once the process is over, they can be temporarily stored and/or removed for subsequent uses.

The unloading station 20 can be positioned substantially in the immediate vicinity alongside the loading station 14 and therefore share a same area, for example, of a building in which the quenching plant 10 is contained. In this way, the operations, for example, of inbound and outbound transport of the bars P can be facilitated, and the demand for personnel can also be reduced.

We will now describe a quenching machine 17 according to the present invention to cool the steel bars P at exit from the furnace 16.

To understand the advantages provided by using the quenching machine 17 it is important to consider that, as can be seen from FIGS. 3a and 3b, bars P of different diameters have a lower generatrix which remains at a substantially constant distance from an imaginary plane below it, and an upper generatrix which varies its distance from an imaginary plane located above.

This aspect is particularly important during the cooling by means of flows of fluid directed toward the bars P, since known quenching machines are not able to adapt the height of the flow of fluid to the diameter of the bars to be cooled.

As a result, the cooling of the bars can prove to be uneven and/or not symmetrical as the diameter of the bars P varies, in other words, more or less extended portions of the bar can only be partly reached by the fluid and/or are not reached at all by the cooling fluid, this generating unwanted deformations thereof.

The quenching machine 17, on the other hand, has constructive characteristics to obtain a highly uniform cooling of the steel bars P and at the same time a high productivity.

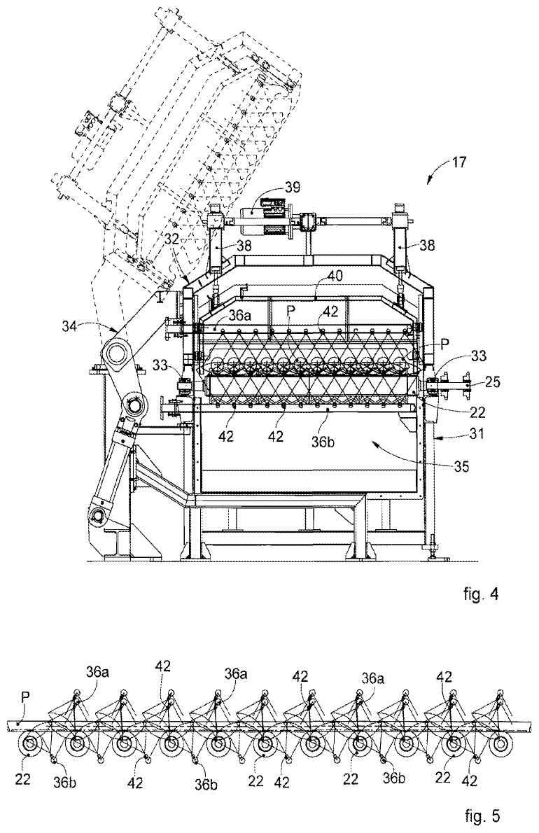

FIGS. 4-5 show sections of a quenching machine 17 provided to meet the needs of the plant 10.

The quenching machine 17 comprises a base 31 and a cover 32, inside which an internal space 35 is made, in which there are housed means for feeding the bars P and a plurality of cooling elements 36a, 36b disposed respectively above and below them and configured to spray cooling liquid on the steel bars P in transit.

The quenching machine 17 comprises feed means configured to allow the simultaneous feed of the bars P, for example in the direction of feed D1. Such feed means can be rollers 22 housed in the internal space 35.

The quenching machine 17 also comprises means 38 and 39 for adjusting in height at least the plurality of cooling elements 36a disposed above the bars P.

The rollers 22 provided in the quenching machine 17 have the same characteristics as those provided in the first furnace 16, that is, they have cavities for housing the individual bars P and are angled by an angle different to 90° with respect to the direction of feed D1 to determine the rotation of the bars P on their axis as they are fed.

In the solution shown, the quenching machine is divided into six sections, although this only represents a non-limiting example. Each section can be adjusted independently of the other sections in terms of flow rate and pressure of the cooling fluid.

The cover 32 can be mobile with respect to the base 31 by means of a lifting member 34, this allowing the cover 32 to be disengaged from the base 31 and to configure the quenching machine 17 in a closed configuration or in an open configuration.

The closed configuration is the configuration adopted for the process for quenching the bars, while the open configuration is particularly advantageous for the maintenance of the internal elements.

The base 31 comprises bearings 33 opposite each other and aligned longitudinally and transversely, said bearings 33 being provided to house two ends of the shaft 25 of the rollers 22.

The means for adjusting the height of the cooling elements 36a can be disposed for example on the cover 32. For example, on the cover 32 there can be provided at least one motor 39 to drive jacks 38 disposed at least partly inside the structure of the cover 32 so that one of their ends is partly inside the internal space 35.

The jacks 38 can be disposed on two substantially parallel lines which can extend at least partly along the longitudinal development of the cover 32.

The jacks 38 can also be aligned with each other along the transverse axis of the cover 32.

A shell 40 is fixed below the cover 32, at the end of the jacks 38 present in the internal space 35.

To the shell 40, and below it, there is connected a plurality of cooling elements 36a in a manner substantially parallel to the plane of the roller 22 below.

By driving the jacks 38 it is possible to adjust the height of the plurality of cooling elements 36a with respect to the transit plane of the steel bars P below, depending on, for example, the diameter of the bars which at that moment have to be cooled.

According to some embodiments, the plurality of cooling elements 36a has a stroke which can be comprised between 80 mm and 90 mm.

A plurality of cooling elements 36b is associated with the base 31, disposed on a plane below that of the roller 22 and substantially parallel to it.

The pluralities of cooling elements 36a, 36b comprise a series of nozzles 42 disposed along their longitudinal axis which are configured to spray cooling fluid toward the steel bars P.

According to some embodiments, the cooling fluid can be water or mixtures with different concentrations of polymer, or natural and/or mineral oil or other suitable quenching means.

The quantity of cooling fluid can be adjusted according to, for example, the diameter of the steel bars P to be treated and/or the height of the nozzles 42 and/or other parameters.

The quenching machine 17 can be provided and/or associated with plants for feeding the fluid and/or cleaning and recirculating it (not shown), suitable to satisfy the operating needs for which the machine 17 is made.

The nozzles 42 are configured to be oriented, that is, spray cooling fluid, at an angle, with respect to the horizontal plane of the rollers, comprised between 20° and 45°, preferably between 25° and 40°, more preferably between 25° and 35° (FIG. 5). The nozzles 42 can be motorized to vary the delivery angle even during the transit of the bars P below, or above, them.

Advantageously, the nozzles 42 are oriented in the direction the steel bars P are fed.

The number of nozzles 42 can preferably be equal to the number of cavities 24, or greater or smaller.

Some embodiments provide that the nozzles 42 can be equidistant from each other.

The plurality of cooling elements 36a, 36b can be disposed staggered with respect to each other so that the angle between them is comprised between 30° and 90°, preferably between 40° and 80°, even more preferably between 55° and 65°.

According to preferred embodiments, the cooling elements 36a can be oriented so as to be perpendicular, or angled according to a desired angle, with respect to the rollers 22 below.

The cooling elements 36a, 36b can have a development in length with respect to the longitudinal axis of the quenching machine 17 comprised between 3 m and 8 m, preferably between 3 m and 7 m, even more preferably between 4.5 m and 5.5 m.

The plurality of cooling elements 36a, 36b are distanced from each other by a length comprised between 300 mm and 800 mm, preferably between 400 mm and 700 mm, more preferably between 450 mm and 550 mm.

Some embodiments provide that the plurality of cooling elements 36a, 36b are preferably but not necessarily equidistant from each other.

The plurality of cooling elements 36a, 36b can be comprised between 4 and 24, preferably between 6 and 20, more preferably between 8 and 16, even more preferably between 10 and 14.

Thanks to the distribution of the nozzles 42 both above and also below the feed plane defined by the rollers 22, to the fact that the nozzles 42 can be oriented and directed in a desired manner, to the possibility of finely adjusting the flow rate and pressure of the cooling fluid in a differentiated manner between the sections, as well as to the use of the rollers 22 which allow to rotate the bars 22 as they are fed, the following are achieved: an optimal uniformity of treatment, a reduced environmental impact thanks to the possibility of not using polymers for most of the steels, as well as an easy adaptation of the parameters to the different treatment conditions.

In summary, by means of the present invention it is possible to maintain the surfaces of the treated bars P equidistant with respect to the “spray mouths” of the upper and lower nozzles 42 provided in the quenching machine 17.

The bars P being treated can change in diameter, for example 15 mm bars, 30 mm bars can be treated in sequence; then 50 mm bars; then again 30 mm; and so on.

In this situation, while the “lower generatrix” of each of the bars P passing through the plant 10 is always in the same position with respect to the injection point of the quenching fluid, that is, the mouth of the lower nozzles 42, the upper generatrix, since the bars P sre supported by rollers 22 which support them from below, would tend to move closer to the mouth of the upper nozzles 42.

This situation, which is in itself very dangerous since it is capable of producing distorting effects on the bars caused by an uneven cooling, is instead addressed and resolved, with the present invention, by means of appropriate measures.

Thanks to the suitable drive of the motor 39 and of the jacks 38, it is possible to vertically translate the upper part of the structure that supports the corresponding manifolds for distributing the quenching fluid, or the cooling elements 36a provided with the nozzles 42.

The invention therefore allows to guarantee a vertical translation of said upper part of the quenching machine 17, maintaining the same upper part absolutely coplanar with the lower part, where the cooling elements 36b and the corresponding nozzles 42 are located, in order to always guarantee a perfect distribution of uniform cooling both from above and also from below. The potential distorting effect is therefore prevented and eliminated.

The invention, since it has to produce a uniformity of cooling of the “carpet of bars” P being fed and rotated at the same time, as well as automated actions for maintaining the symmetry of spray on the surfaces of the bars, also provides a distribution of the cooling manifolds, that is, the cooling elements 36a and 36b, designed to completely and correctly cover the cooled surface.

Since the cooling elements 36a are also vertically mobile, according to the above described coplanar lifting logic of the upper spraying surface, the nozzles 42 are also configured to optimize the action of delivering the cooling fluid.

As can be seen from FIG. 4 and FIG. 5 and as previously described, the nozzles 42 of the cooling elements 36a are oriented so as to have spraying cones suitable to guarantee an effective and uniform spraying of cooling fluid on the bars P, without generating overlap or interference between them, and excessive distances between one and the other. As seen, the angles of orientation of the nozzles 42, with respect to the horizontal plane defined by the rollers 22, can be comprised between 20° and 45°, preferably between 25° and 40°, more preferably between 25° and 35°.

The present quenching machine 17 also proves to be extremely advantageous with respect to known quenching machines consisting of one or more “rings”, each suitable to cool one bar by means of sprays directed radially and/or tangentially to the bar.

The rings with spray radial to the bar have the disadvantage of having to be made effective by being frequently interchanged; if the diameter of the bar varies excessively, the quenching ring has to be replaced with another one, more suited to the new bar geometry.

The rings with spray tangential to the bar, more adaptable as the geometry varies, have the disadvantage of requiring considerable bulks for the mechanics necessary to drive the orientation of the sprays which have to remain tangent to the surface of the bar as its diameter varies: this last type of rings, therefore, although particularly effective in the case of a single bar or in the case of low productivity requirements, is poorly suited for high productivity “multi-bar” solutions.

The present quenching machine 17 overcomes both concepts: the extreme attention paid to the symmetry of the cooling system in the present invention allows to face production campaigns of “quenched” product without changing the arrangement of the machine in any way, except with variations of the opening of the machine commanded automatically by the general control system of the treatment line which, knowing the diameter of the bars arriving at the machine, allows to set its opening.

This continuity in functioning therefore guarantees substantial production “recoveries” since the invention practically eliminates the usual temporal phases of “plant setup” used when it is necessary to optimize the quenching system, adapting it to the actual bars treated.

The mobile cover 32 allows to completely open the machine in order to carry out periodic maintenance or other.

In the present quenching machine 17, since it is necessary to deal with the issue of a large variation in the diameter of bars and an almost infinite range of qualities of steel which they are made of, it is also possible to use more than one cooling fluid or quenching mean and more than one condition of different equilibrium in the search for rapid or less rapid quenching.

The concentration of quenching fluid can be varied in the different zones of the quenching machine 17, or it can be maintained constant in the various zones of the machine. Therefore the invention has a cooling fluid dynamics which can be divided into zones, by means of manifolds or cooling elements on a determinate machine length.

The possibility of using different quenching fluids allows to adapt the quenching machine 17 to the different steel qualities with which the bars P subject to quenching are made. A quenching fluid such as water, suitable for a determinate type of steel, may not be suitable for other steels and cause cracking or other phenomena. Therefore, the present machine can use various types of quenching fluid starting from water, whose entry temperature can be modulated, reaching an infinite series of gradations of water-polymer mixture, or even quenching oil or other.

The feed speed of the bars was then made adjustable to allow to increase or decrease the simultaneous rotation speed of the bars under the platform of cooling elements and nozzles.

The present quenching plant and the present quenching machine are therefore made in order to facilitate metallurgical results that can be modulated according to requirements.

It is clear that modifications and/or additions of parts may be made to the quenching plant, to the quenching machine and to the quenching method as described heretofore, without departing from the field and scope of the present invention.

It is also clear that, although the present invention has been described with reference to some specific examples, a person of skill in the art shall certainly be able to achieve many other equivalent forms of quenching plant, quenching machine and quenching method, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. A high productivity plant for the continuous quenching of steel bars, comprising:
a loading station suitable to dispose a plurality of bars separated and distanced from each other;
a first treatment line comprising an austenitization furnace to receive said plurality of bars, disposed parallel and adjacent to each other, from said loading station, and to perform a first heat treatment on said bars, in which said austenitization furnace comprises means to simultaneously feed said plurality of bars in a direction of feed and at the same time rotate them on their own axis; wherein said bars are oriented in said direction of feed;
a quenching machine disposed at the exit of said austenitization furnace to perform a rapid cooling treatment on said plurality of bars, said quenching machine comprising a base and a cover, inside which an internal space is made in which there are disposed said means to simultaneously feed said plurality of bars and at the same time rotate them on their own axis, defining a support plane for said bars, and a plurality of cooling elements disposed respectively above and below said means to feed the bars and configured to spray cooling fluid on the steel bars in transit, wherein at least the plurality of cooling elements disposed above the bars is adjustable in height with respect to their feed plane;
a transfer station disposed downstream of said quenching machine, and
a second treatment line, disposed downstream of said transfer station and comprising a quenching furnace to perform a quenching treatment on said plurality of bars.

2. The plant as in claim 1, wherein said second line is parallel to said first treatment line and with the direction of feed of the bars opposite that of the first treatment line.

3. The plant as in claim 1, wherein said second line is aligned or angled with respect to said first treatment line.

4. The plant as in claim 1, wherein said means to simultaneously feed said plurality of bars and at the same time rotate them on their own axis comprise rollers having on a surface thereof a plurality of cavities with a V-shape defined by an angle (α) and disposed at an angle and with an angle different to 90° with respect to the direction of feed.

5. The plant as in claim 4, wherein the number of cavities provided for each roller is comprised between 6 and 18, preferably between 8 and 16, more preferably between 10 and 14.

6. The plant as in claim 4, wherein the angle (α) is comprised between 100° and 130°, preferably between 110° and 120°.

7. The plant as in claim 1, wherein said second treatment line has rollers disposed substantially orthogonal to the axis of feed of the bars and having a flat support surface of the bars.

8. A quenching machine for a plant to quench steel bars, comprising a base and a cover, inside which an internal space is made, wherein in said internal space there are disposed feed means to simultaneously feed said plurality of bars and at the same time rotate them on their own axis, said feed means defining a support plane for said bars, and a plurality of cooling elements disposed respectively above and below said feed means and configured to spray cooling fluid on the steel bars in transit, wherein said bars are moved simultaneously by said feed means in a direction of feed along which said bars lie and wherein at least the plurality of cooling elements disposed above the bars is adjustable in height with respect to their feed plane.

9. The quenching machine as in claim 8, wherein said plurality of cooling elements comprises nozzles disposed adjacent and configured to spray cooling fluid toward said steel bars.

10. The quenching machine as in claim 9, wherein said nozzles are configured to be oriented at an angle, with respect to the horizontal plane defined by said means, comprised between 20° and 45°, preferably between 25° and 40°, more preferably between 25° and 35°.

11. The quenching machine as in claim 9, wherein said nozzles are oriented in the direction of feed of the steel bars.

12. The quenching machine as in claim 8, wherein said cover is mobile with respect to the base by means of a lifting member to selectively determine an open condition and a closed condition of said quenching machine.

13. The method Method for the quenching treatment of a plurality of steel bars by means of a plant as in claim 1, comprising:
disposing a plurality of bars separated and distanced from each other;
inserting said plurality of bars in an austenitization furnace, feeding them and at the same time rotating them on their own axis,
subjecting, at the exit of said austenitization furnace, said plurality of bars to a rapid cooling treatment in a quenching machine by feeding said plurality of bars and at the same time rotating them on their own axis, wherein said rapid cooling treatment provides to deliver cooling fluid both from above and also from below said plurality of bars;
transferring said plurality of bars into a quenching furnace, to perform a quenching treatment on said plurality of bars;
discharging said quenched bars from said quenching furnace.
